(19) United States
(12) Patent Application Publication
(10) Pub. No.: US 2024/0159541 A1
(43) Pub. Date: May 16, 2024

(54) INFORMATION PROCESSING APPARATUS, METHOD, SYSTEM, AND STORAGE MEDIUM TO PERFORM REGISTRATION WORK OF AN AREA ASSOCIATED WITH AN ATTRIBUTE

(71) Applicant: YAMAHA HATSUDOKI KABUSHIKI KAISHA, Iwata-shi (JP)

(72) Inventors: Hirofumi AMMA, Shizuoka (JP); Hidenori SATAKE, Shizuoka (JP); Yukitaka OKAMOTO, Shizuoka (JP); Hideyoshi SATO, Shizuoka (JP)

(21) Appl. No.: 18/506,237

(22) Filed: Nov. 10, 2023

(30) Foreign Application Priority Data
Nov. 16, 2022 (JP) 2022-183424

(51) Int. Cl. G01C 21/20

(52) U.S. Cl. CPC G01C 21/203

(57) ABSTRACT

An information processing apparatus to perform registration work of an area associated with an attribute includes at least one processor configured or programmed to transmit a map including information on a boundary between a land area and a water area; acquire a designated boundary range among boundaries on the map, a designated distance, and a designated attribute; set an attribute target area based on the designated boundary range and the designated distance, and associate the designated attribute with the attribute target area; and update the map by including the attribute target area associated with the attribute in the map.

### CROSS REFERENCE TO RELATED APPLICATIONS

This application claims the benefit of Japanese Patent Application No. 2022-183424, filed Nov. 16, 2022, the entire contents of which are hereby incorporated herein by reference.

### BACKGROUND OF THE INVENTION

### 1. Field of the Invention

The present invention relates to an information processing apparatus, a method, a system, and a storage medium that perform registration work of an area associated with an attribute.

### 2. Description of the Related Art

Conventionally, there has been known an information processing apparatus that sets and registers an area (referred to as an “attribute target area”) associated with attributes such as some sort of restriction such as entry prohibition or slowdown on a map such as a chart. It takes man-hours to set the attribute target area while measuring the distance or the like for each place by themselves. Therefore, for example, Japanese Laid-Open Patent Publication (Kokai) No. 2002-324241 discloses a technique of setting a traveling avoidance line by operating an electronic chart displayed on a touch panel using a touch pen. In addition, Japanese Patent No. 4023029 discloses a technique of calculating the values of latitude and longitude on a circumference of a predetermined radius centered on each point of coastline data at intervals of a certain angle and automatically creating territorial sea line data.

However, considering that there are individual situations depending on locations and the like, it is still not easy to set and register an appropriate attribute target area corresponding to a long coastline. Therefore, there is room for improvement in facilitating the registration work of the attribute target area.

### SUMMARY OF THE INVENTION

Preferred embodiments of the present invention provide information processing apparatuses, methods, systems, and storage mediums each able to easily perform registration work of an area associated with an attribute.

According to a preferred embodiment of the present invention, an information processing apparatus includes at least one memory to store a set of instructions, and at least one processor configured or programmed to cause the information processing apparatus to transmit a map including information on a boundary between a land area and a water area; acquire a designated boundary range among the boundaries on the map, a designated distance, and a designated attribute; set an attribute target area based on the designated boundary range and the designated distance, and associate the designated attribute with the attribute target area; and update the map by including the attribute target area associated with the attribute in the map.

According to this configuration, a map including information on a boundary between a land area and a water area is transmitted; a designated boundary range of boundaries on a map, a designated distance, and a designated attribute are acquired; the attribute target area is set based on the designated boundary range and distance; and the designated attribute is associated with the attribute target area, and the attribute target area associated with the attribute is reflected on the map.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram illustrating a configuration of an information processing system according to a preferred embodiment of the present invention.

FIG. 2 is a block diagram of a main portion of the information processing system.

FIG. 3 is a diagram illustrating an image displayed when a map is updated.

FIG. 4 is a diagram illustrating a functional block that implements a map update process in a server.

FIG. 5 is a flowchart illustrating a map update process.

FIGS. 6A and 6B show an example of transition of screens displayed in the map update process.

FIGS. 7A and 7B show an example of transition of screens displayed in the map update process.

FIG. 8 is a flowchart illustrating a notification process.

### DETAILED DESCRIPTION OF THE PREFERRED EMBODIMENTS

Hereinafter, preferred embodiments of the present invention will be described with reference to the drawings.

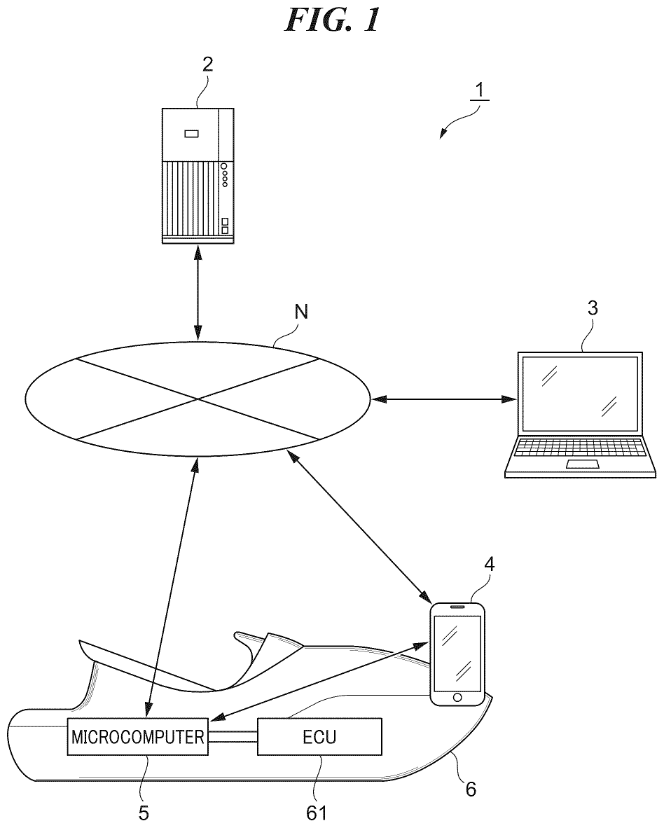

FIG. 1 is a diagram illustrating a configuration of an information processing system 1 according to a preferred embodiment of the present invention.

The information processing system 1 includes a server 2, a PC terminal 3, a mobile terminal 4, a microcomputer 5, and an engine control unit (ECU) 61. The ECU 61 is mounted on a marine vessel 6. The type of the marine vessel 6 is not limited. The server 2, the PC terminal 3, the mobile terminal 4, and the microcomputer 5 are connected to communicate with one another wirelessly and/or by wire via a network N. The mobile terminal 4 and the microcomputer 5 are directly connected and communicable with each other in a wired or wireless manner. Note that the numbers of each component included in the information processing system 1 may be two or more.

The PC terminal 3 may be a personal computer (PC). The PC terminal 3 may be a smartphone, a tablet, a mobile phone, a notebook PC, or a wearable computer.

The mobile terminal 4 is a mobile terminal attached to the marine vessel 6. The mobile terminal 4 may be held by a person on board the marine vessel 6. The mobile terminal 4 is typically a smartphone, or may be an information processing apparatus such as a PC, a tablet, a mobile phone, a notebook PC, or a wearable computer.

The microcomputer 5 is an information processing apparatus including a semiconductor device mounted on a substrate built in the marine vessel 6 or a combination of a semiconductor device and an electronic component. The microcomputer 5 is realized by hardware, firmware or software, or a combination thereof.

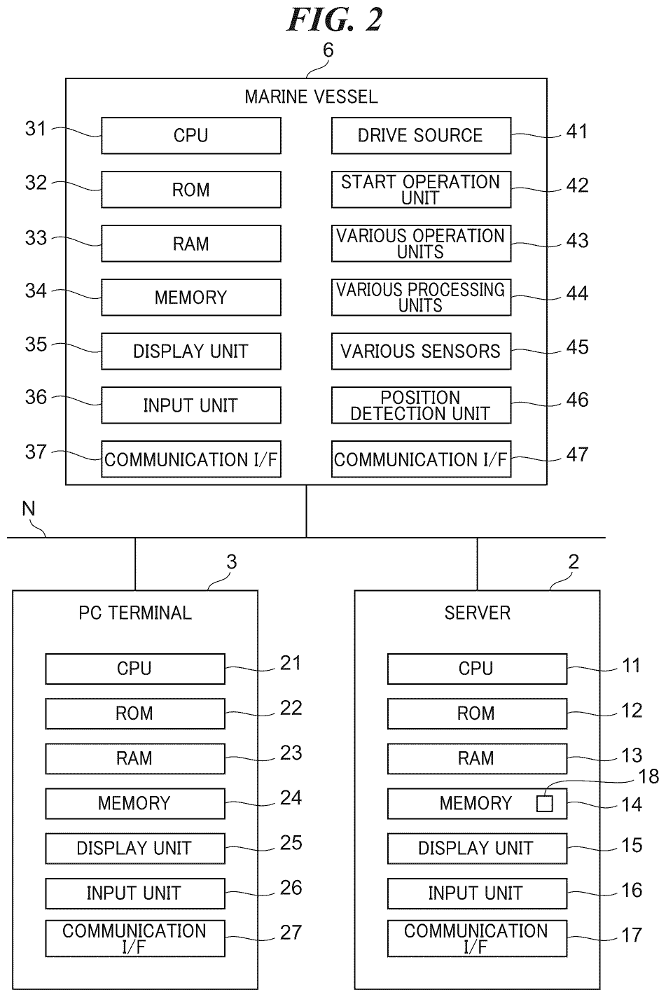

FIG. 2 is a block diagram of a main portion of the information processing system 1. The marine vessel 6 includes a CPU 31, a ROM 32, a RAM 33, a memory 34, a display unit 35, an input unit 36, a communication interface (I/F) 37, and a timer (not illustrated). The ROM 32 or the memory 34 stores a control program. The microcomputer 5 (FIG. 1) includes the CPU 31, the ROM 32, the RAM 33, the memory 34, and the like.

The CPU 31 implements various control processes by developing a control program stored in the ROM 32 or the like in the RAM 33 and executing the control program. The RAM 33 provides a work area when the CPU 31 executes the control program. The display unit 35 displays various types of information. The input unit 36 receives an input of a set value and an input of a mode from a marine vessel operator of the marine vessel 6. The communication I/F 37 is able to communicate with the network N, and is also able to communicate with the ECU 61 (FIG. 1) that controls the drive source 41 by a controller area network (CAN) or the like.

The marine vessel 6 includes the drive source 41, a start operation unit 42, various operation units 43, various processing units 44, various sensors 45, a position detection unit 46, and a communication I/F 47.

The start operation unit 42 is a start switch or the like to input an instruction to start the drive source 41. The various operation units 43 are operation units operated by a marine vessel operator to steer the marine vessel, such as a steering wheel and a remote controller. The various operation units 43 are also used by the vessel operator to input various settings. The various processing units 44 include the ECU 61 and process various operations related to the marine vessel 6. The various sensors 45 include sensors that detect operations of the various operation units 43.

Furthermore, the various sensors 45 may include an acceleration sensor, a velocity sensor, an angular velocity sensor, and the like (none of which are illustrated). The position detection unit 46 receives a GPS signal from a global positioning system (GPS) satellite, and outputs position information indicating the current position of the marine vessel 6. The communication I/F 47 is able to communicate with the communication I/F 37 via CAN or the like.

The server 2 includes a CPU 11, a ROM 12, a RAM 13, a memory 14, a display unit 15, an input unit 16, a communication I/F 17, and a timer (not illustrated). The CPU 11 implements various control processes by developing a control program stored in the ROM 12 or the memory 14 in the RAM 13 and executing the control program. The RAM 13 provides a work area when the CPU 11 executes the control program. The display unit 15 displays various types of information. The input unit 16 receives inputs of various settings and inputs of various instructions from the user of the server 2. The memory 14 stores applications that implement various processes. The memory 14 also stores a map 18 to be described below. The server 2 manages the map 18. The communication I/F 17 is able to communicate with the network N.

The PC terminal 3 includes a CPU 21, a ROM 22, a RAM 23, a memory 24, a display unit 25, an input unit 26, a communication I/F 27, and a timer (not illustrated). The configurations of the CPU 21, the ROM 22, the RAM 23, the memory 24, and the display unit 25 are basically similar to those of the CPU 11, the ROM 12, the RAM 13, the memory 14, and the display unit 15 of the server 2, respectively. The input unit 26 receives inputs of various settings and inputs of various instructions from the user of the PC terminal 3. The communication I/F 27 is able to communicate with the network N. Furthermore, the communication I/F 27 has a short-range wireless communication function such as Bluetooth (registered trademark). The memory 24 stores an application downloaded from the server 2.

The numbers of each of the marine vessel 6, the mobile terminal 4, and the PC terminal 3, which are communicably connected to the server 2 may be two or more. Note that the communication I/Fs 17, 27, 37, and 47 may include a plurality of communication functions, and a method of the communication functions may be wired or wireless. In addition, any of the communication I/Fs 17, 27, 37, and 47 may have a function of communicating with the network N, and/or may have a near field communication function.

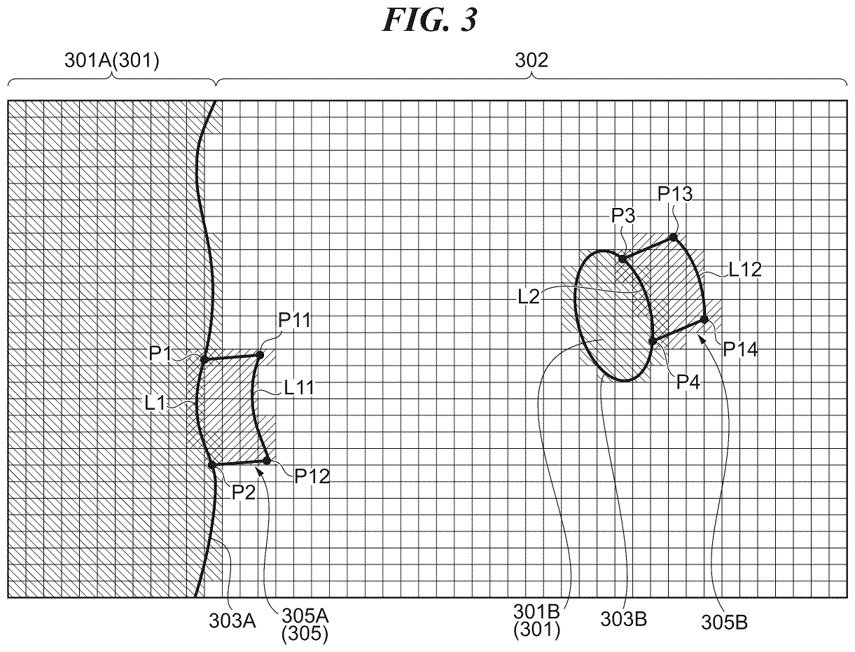

FIG. 3 is a diagram illustrating an image displayed on the display unit 25 of the PC terminal 3 when the map 18 is updated.

Each PC terminal 3 is a computer associated with an administrator who has authority to set an attribute target area (described later) for a specific area that is a portion of the area on the map 18. The specific area is, for example, a specific marina, and the administrator is a person at the marina, but is not limited thereto.

The specific area is associated with the administrator. The administrator is associated with his/her PC terminal by an ID or the like given individually. Accordingly, the specific area is substantially associated with the PC terminal 3. Each PC terminal 3 is able to input an instruction to set and register the attribute target area in the specific area corresponding to the administrator on the map 18 in accordance with the operation by the administrator. The server 2 updates the map 18 by setting and/or changing the attribute target area in the specific area corresponding to the administrator on the map 18 based on the information set and/or changed in each PC terminal 3, and registering a new attribute target area and/or a changed attribute target area.

An area in which the attribute target area can be updated among all the areas on the map 18 is divided into a plurality of specific areas. The PC terminal 3 exists for each specific area. By dividing the updatable areas, it is possible to distribute work of updating the attribute target area. The map 18 is appropriately transmitted to the PC terminal 3 and/or the marine vessel 6. FIG. 3 illustrates an example of a screen displayed on the PC terminal 3 associated with a certain administrator. The process of updating the map 18 is executed by the server 2, and a screen during updating or a screen after updating is transmitted from the server 2 to the PC terminal 3 as needed and displayed on the PC terminal 3.

Referring to FIG. 3, the map 18 is map information including information on a boundary between the land area 301 (301A, 301B) and the water area 302 (hereinafter referred to as a “water-land boundary”). The land area 301 includes a land area 301A which is land and a land area 301B which is an island. The water-land boundary includes a boundary 303A between the land area 301A and the water area 302 and a boundary 303B between the land area 301B and the water area 302. Note that a pier, an obstacle exposed from a water surface, and the like may also be included in the land area 301.

The attribute target area 305 is an area associated with the designated “attribute”. The attribute here includes at least one of “the area is a speed limit area in which the navigation speed is limited”, “the area is an audio limit area in which audio volume is limited”, or “the area is an entry prohibited area in which entry of a marine vessel is prohibited”. However, the attribute is not limited to any limitation, and may include other information. For example, the attribute may be “the area indicates that the marine vessel is not subject to a warning”, for example, “the area is a wake area, a fishing spot (area suitable for fishing), or the like”.

The server 2 manages the attribute target area in units of tiles each of which is a region obtained by dividing a region on the map 18 into a mesh shape, that is, a lattice shape. That is, the tiles are formed of or defined by a mesh. Each tile is specified by, for example, a tile coordinate. The tile coordinate is defined by coordinate in two directions orthogonal to each other.

The tile corresponding to the attribute target area is a tile with which “attribute” is associated, and this tile is referred to as “attribute target tile”. The information regarding the attribute target tile is referred to as “attribute target tile information”. The attribute target tile information includes information to associate an attribute with a tile. Since the attribute is associated with the tile corresponding to the attribute target area among the plurality of tiles, various processes are simplified.

The map 18 includes attribute target tile information. Note that the map 18 may not include the attribute target tile information in an initial state in which the attribute target area 305 is not registered for any specific area.

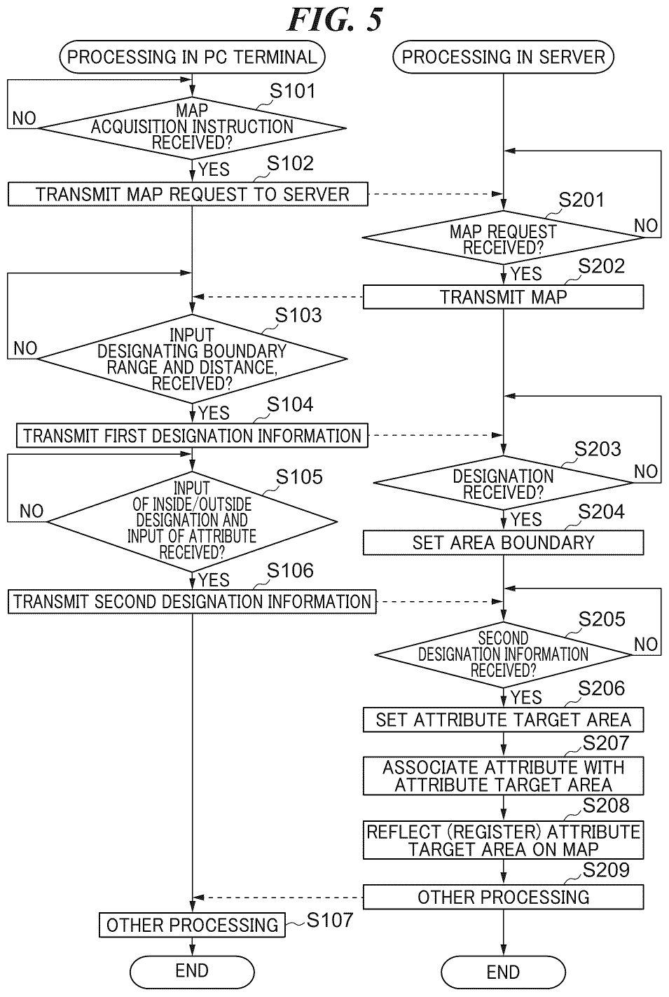

The process of including the attribute target area in the map 18 will be outlined by taking the process related to the boundary 303A as an example with reference to FIG. 3. Details of this process will be described below with reference to FIG. 5.

Based on the operation of the administrator, the PC terminal 3 designates two points (first point P1, second point P2) on the water-land boundary (here, the boundary 303A) on the map 18, thus designating the range between these two points as the boundary line L1 (boundary range) in the specific area. The boundary line L1 is a line on the boundary 303A connecting the first point P1 and the second point P2 (that is, a line along the boundary 303A between the first point P1 and the second point P2). Note that a line segment connecting the first point P1 and the second point P2 may be the boundary line L1.

The PC terminal 3 accepts designation of the distance and designation of the attribute based on the operation of the administrator. In a case where the administrator desires to associate an attribute such as a limit with a specific area corresponding to the administrator himself/herself, the administrator designates a desired distance and attribute. Accordingly, the PC terminal 3 transmits the designated boundary line L1, the designated distance, and the designated attribute to the server 2.

The server 2 receives and acquires the designated information, sets the attribute target area based on the designated boundary line L1 and the distance, and associates the designated attribute with the attribute target area.

For example, the server 2 sets, as an area boundary, a position spaced apart from the boundary line L1 by a designated distance on the opposite side of the boundary line L1 from the land area 301A. In the example of FIG. 3, an area boundary line L11 is set as an area boundary. Then, the server 2 sets the attribute target area 305A with the area boundary line L11 as a reference.

Thereafter, the server 2 updates the map 18 by including the attribute target area 305A associated with the attribute in the map 18. During the setting of the attribute target area 305A, the server 2 transmits a screen indicating the setting status of the specific area to the PC terminal 3 at any time. When the update of the map 18 is completed, the server 2 transmits the updated map 18 and the completion notification to the PC terminal 3.

Note that a similar way is applied to the process related to the boundary 303B. Namely, the PC terminal 3 designates a range between two points (point P3, P4) on the boundary 303B as the boundary line L2, and transmits the designated boundary line L2, the designated distance and the designated attribute to the server 2. The server 2 sets, as the area boundary line L12, a line that passes through the point P13 and the point P14 and is parallel to the boundary line L2. Further, the server 2 sets the attribute target area 305B with the area boundary line L12 as a reference. Note that, regarding the distance and the attribute, the designation related to the boundary 303A and the designation related to the boundary 303B are not necessarily the same. Therefore, the distance and the attribute can be independently designated for each boundary line.

Note that the server 2 manages whether the area is an attribute target area or not in units of tiles. For this management, a tile corresponding to the attribute target area 305 among the plurality of tiles is set and registered. At that time, the server 2 treats a tile including the boundary line L1 or the area boundary line L11 as a tile corresponding to the attribute target area 305A. In addition, the server 2 treats a tile including the boundary line L2 or the area boundary line L12 as a tile corresponding to the attribute target area 305B. In addition, regarding the water-land boundary, the server 2 treats a tile including the boundary 303A as a tile corresponding to the land area 301A, and treats a tile including the boundary 303B as a tile corresponding to the land area 301B.

However, this may be reversed. That is, a tile including a boundary line or an area boundary line may be treated as a tile not corresponding to the attribute target area. In addition, tiles including the boundary 303A and the boundary 303B may be treated as tiles not corresponding to the land area 301A and the land area 301B, respectively.

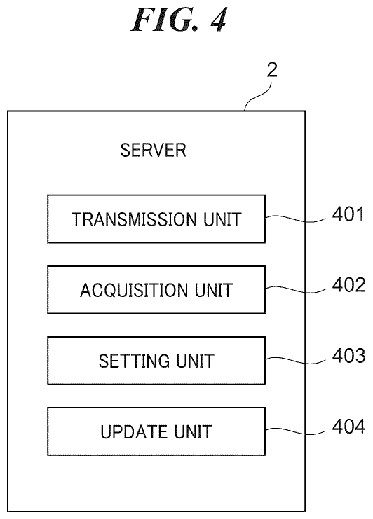

FIG. 4 is a diagram illustrating a functional block that implements a map update process in the server 2. The functional block includes, as functional units, a transmission unit 401, an acquisition unit 402, a setting unit 403, and an update unit 404. These functional units are mainly implemented by cooperation of any two or more of the CPU 11, the ROM 12, the RAM 13, the memory 14, and the communication I/F 17 of the server 2.

The transmission unit 401 transmits the map 18 to the PC terminal 3. The acquisition unit 402 acquires the designated boundary range (such as the boundary line L1) on the map 18, the designated distance, and the designated attribute by receiving them from the PC terminal 3. The setting unit 403 sets the attribute target area (such as the attribute target area 305) based on the designated boundary range and the designated distance, and associates the designated attribute with the attribute target area. The update unit 404 updates the map 18 by including the attribute target area associated with the attribute in the map 18.

FIG. 5 is a flowchart illustrating a map update process. This map update process is executed by the server 2 and the PC terminal 3 in cooperation. The map update process includes a process in the PC terminal executed by the PC terminal 3 and a process in the server executed by the server 2. The process in the PC terminal and the process in the server will be described in parallel to describe the map update process.

In the PC terminal 3, the CPU 21 develops a program stored in the ROM 22 or the memory 24 in the RAM 23 to execute the program, thus implementing the process in the PC terminal. In the server 2, the CPU 11 develops a program stored in the ROM 12 or the memory 14 in the RAM 13 to execute the program, thus implementing the process in the server. The map update process is started when the PC terminal 3 transmits a registration start instruction to the server 2.

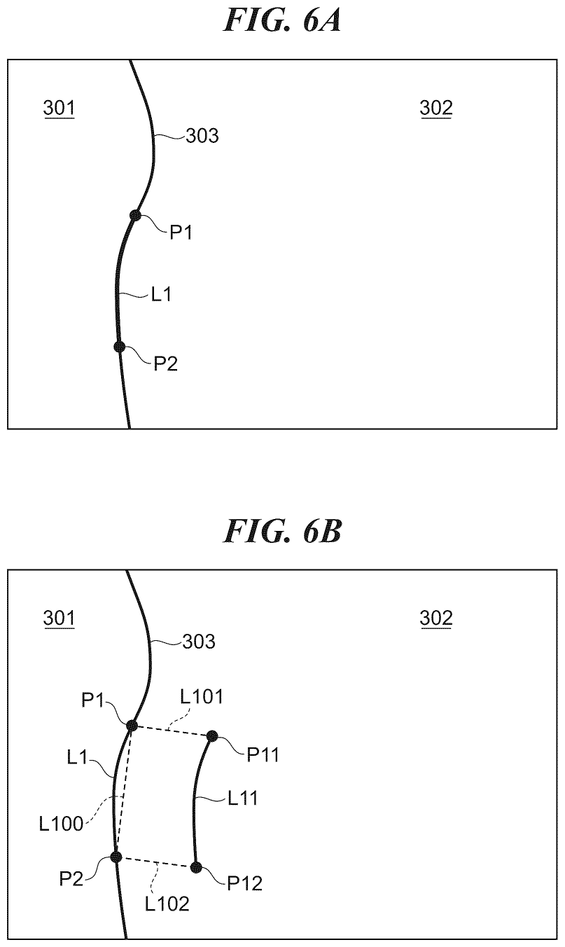

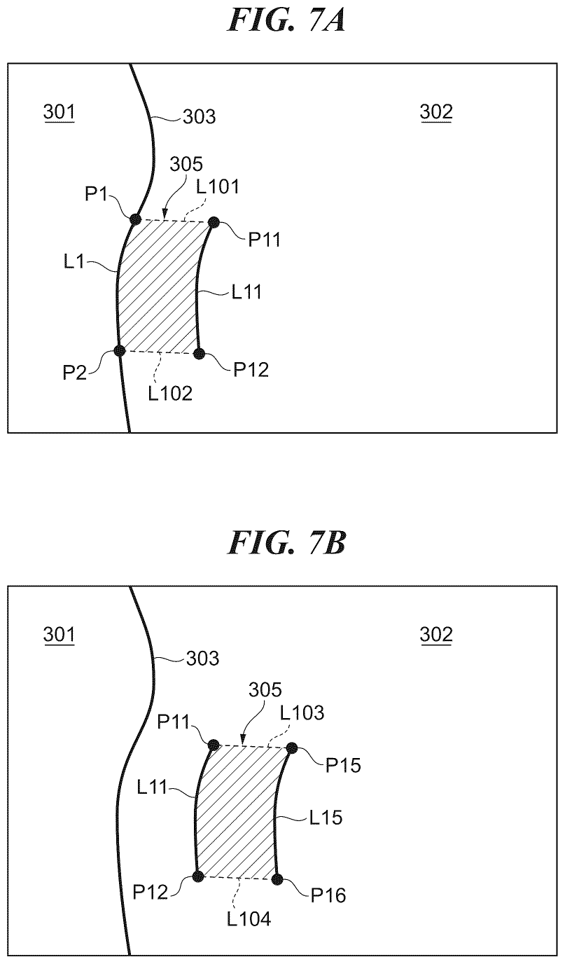

FIGS. 6A, 6B, 7A, and 7B show an example of a transition of screens displayed on the display unit 25 of the PC terminal 3 in the map update process. Note that, in FIGS. 6A to 7B, illustration of the tile is omitted, and the state of process is schematically illustrated. Therefore, in the following description of the map update process (also referring to FIGS. 6A to 7B), the expression that the attribute target area is set for each tile is omitted.

First, in step S101, the CPU 21 waits until an instruction to acquire a map is given (until receiving a map acquisition instruction) from the administrator. Upon receiving the map acquisition instruction, the CPU 21 requests the server 2 to transmit a map (transmits a map request) in step S102. In step S201, the CPU 11 of the server 2 waits until the map request is received. When receiving the map request, the CPU 11 advances the process to step S202. In step S202, the CPU 11 transmits the map 18 to the PC terminal 3 that is the transmission source of the map request. The map 18 transmitted here may need only to include a specific area corresponding to the PC terminal 3. Note that in a case where the PC terminal 3 already has a map, the processes of steps S101, S102, S201, and S202 may be omitted.

In step S103, the CPU 21 of the PC terminal 3 waits until receiving an input designating the boundary range and the distance. When receiving the designation of the boundary range and the distance, the CPU 21 advances the process to step S104. For example, as illustrated in FIG. 6A, the administrator designates the first point P1 and the second point P2 using the input unit 26, such as a mouse, on the boundary 303 which is the water-land boundary. The CPU 21 designates a boundary line L1, which is a range between the points P1 and P2, as a boundary range in the specific area. The boundary line L1 is a line on the boundary 303 connecting the point P1 and the point P2. The distance is designated by input of a numerical value or the like.

In step S104, the CPU 21 transmits the designated boundary line L1 and the designated distance (which are referred to as “first designation information”) to the server 2. In step S203, the CPU 11 of the server 2 waits until receiving (acquiring) the first designation information from the PC terminal 3. When receiving the first designation information, the CPU 11 advances the process to step S204.

In step S204, the CPU 11 of the server 2 sets the area boundary based on the boundary line L1 and the distance in the first designation information. For example, as illustrated in FIG. 6B, the CPU 11 sets an area boundary line L11 as an area boundary at a position spaced apart from the boundary line L1 by the designated distance on the opposite side of the boundary line L1 from the land area 301. As an example, the area boundary line L11 is a line obtained by translating the boundary line L1 by the designated distance in a direction perpendicular to the straight line L100 connecting the point P1 and the point P2 and on the opposite side of the boundary line L1 from the land area 301.

Specifically, the CPU 11 sets, as a point P11, a position which is spaced apart from the point P1 by the designated distance and is on a straight line L101 that passes through the point P1 and is perpendicular to the straight line L100. The CPU 11 sets, as a point P12, a position which is spaced apart from the point P2 by the designated distance on a straight line L102 passing through the point P2 and perpendicular to the straight line L100. Then, the CPU 11 sets, as the area boundary line L11, a line passing through the point P11 and the point P12 and parallel to the boundary line L1.

The method of setting the area boundary line L11 from the points P1 and P2 is not limited to the illustrated method. For example, the direction in which the area boundary line L11 is spaced apart from the straight line L100 is not limited to the perpendicular direction to the straight line L100, and may be determined by designation by the administrator. Note that the straight lines L100, L101, L102, points P11, P12, and the area boundary line L11 are information necessary for internal process in the server 2, which have no necessity to be actually displayed on a screen in the PC terminal 3 or the server 2.

In step S105, the CPU 21 of the PC terminal 3 waits until receiving the input of the inside/outside designation and the input designating the attribute. Upon receiving the input of the inside/outside designation and the input designating the attribute, the CPU 21 advances the process to step S106. Here, the inside/outside designation is designation indicating the inside or the outside of the area boundary. That is, the inside/outside designation information is information to designate whether to provide the attribute target area on the land side or on the opposite side of the land with respect to the area boundary.

In step S106, the CPU 21 transmits the inside/outside designation information and the designated attribute (which are referred to as “second designation information”) to the server 2. In step S205, the CPU 11 of the server 2 waits until receiving (acquiring) the second designation information from the PC terminal 3. When receiving the second designation information, the CPU 11 advances the process to step S206. Note that the PC terminal 3 may collectively designate the first designation information and the second designation information and transmit them to the server 2, and the server 2 may collectively acquire them.

In step S206, the CPU 11 sets the attribute target area for each tile based on the boundary line L1, the area boundary line L11, and the inside/outside designation information. For example, in a case where the inside/outside designation information indicates “inside of area boundary”, the CPU 11 sets the attribute target area on the land side with respect to the area boundary. That is, as illustrated in FIG. 7A, the CPU 11 sets an area between the boundary line L1 and the area boundary line L11 as the attribute target area 305. In this case, the CPU 11 sets an area surrounded by the boundary line L1, the area boundary line L11, the straight line L101 and the straight line L102 as the attribute target area 305. Tiles including the boundary line L1, the area boundary line L11, the straight line L101 and the straight line L102 are also included in the attribute target area 305.

On the other hand, in a case where the inside/outside designation information indicates “outside of area boundary”, the CPU 11 sets the attribute target area on the opposite side of the land with respect to the area boundary. That is, as illustrated in FIG. 7B, the CPU 11 sets an area opposite to the boundary line L1 with respect to the area boundary line L11 as the attribute target area 305. In FIG. 7B, points P15 and P16 are points obtained by moving the points P11 and P12 by the designated distance in a direction perpendicular to the straight line L100 connecting the point P1 and the point P2 and on an opposite side of the area boundary line L11 from the land area 301. A line L15 is obtained by translating the area boundary line L11 by the designated distance in a direction perpendicular to the straight line L100 and on the opposite side of the area boundary line L11 from the land area 301. The CPU 11 sets a region surrounded by a line segment L103 connecting the point P11 and the point P15, a line segment L104 connecting the point P12 and the point P16, an area boundary line L11 and a line L15 as the attribute target area 305. Tiles including the line segment L103, the line segment L104, the area boundary line L11 and the line L15 are also included in the attribute target area 305.

In step S207, the CPU 11 associates the designated attribute with the attribute target area 305. As a result, the attribute target tile information is associated with the attribute target tile. In step S208, the CPU 11 registers the attribute target area of the map 18 by including the attribute target area 305 in the map 18 (updating the map 18).

In step S209, the CPU 11 executes other processes and ends the process in the server. In other processes performed by the server, the CPU 11 may notify the PC terminal 3 that the update of the map 18 has been completed. Further, the CPU 11 may transmit the updated map 18 to the PC terminal 3.

In step S107, the CPU 21 of the PC terminal 3 executes other processes and ends the process in the PC terminal. In the other processes performed by the PC terminal, in a case where a notification indicating that the update is completed is received from the server 2, the CPU 21 may notify that the update is completed. In a case where the updated map 18 is received from the server 2, the CPU 21 may cause the display unit 25 to display the specific area on the map 18 corresponding to the administrator (that is, corresponding to the PC terminal 3).

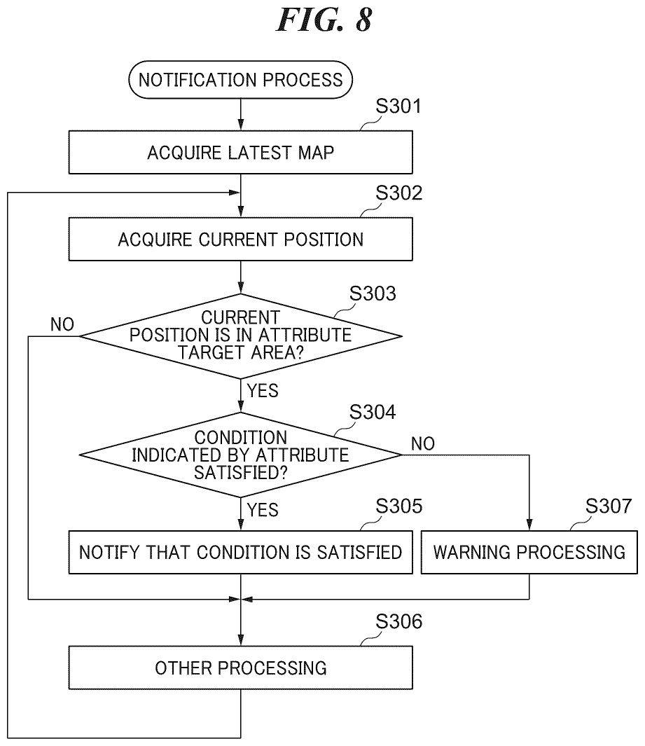

FIG. 8 is a flowchart illustrating a notification process. In the microcomputer 5 of the marine vessel 6, the CPU 31 develops a program stored in the ROM 32 or the memory 34 in the RAM 33 to execute the program, thus implementing the notification process. The notification process is started when the microcomputer 5 is activated. Alternatively, the notification process is started when the vessel operator instructs, via the input unit 36, to start the notification process.

In step S301, the CPU 31 acquires the latest map 18. For example, the CPU 31 transmits a request to acquire the latest map 18 to the server 2, and acquires the map 18 returned from the server 2 in response to the request.

In step S302, the CPU 31 acquires the current position of the microcomputer 5 from the position information output from the position detection unit 46. In step S303, the CPU 31 determines whether or not the current position of the microcomputer 5 is in the attribute target area 305. In a case where the current position of the microcomputer 5 is not in the attribute target area 305, there is no need for notification, and thus the CPU 31 advances the process to step S306.

On the other hand, in a case where the current position of the microcomputer 5 is in the attribute target area 305, the CPU 31 advances the process to step S304, and determines whether or not the condition indicated by the attribute corresponding to the attribute target area 305 is satisfied. The “condition indicated by the attribute” is, for example, “a navigation speed is less than a predetermined speed” in a case where the attribute target area 305 is a speed limit area. In a case where the attribute target area 305 is the audio limiting area, the “condition indicated by the attribute” is that “the volume of the audio is less than a predetermined value”. Note that some attributes do not have a condition. In a case where the attribute does not include the condition itself, the “condition indicated by the attribute” is always considered to be satisfied.

In a case where the condition indicated by the attribute is satisfied (YES in S304), the CPU 31 advances the process to step S305. In a case where the condition indicated by the attribute is not satisfied (NO in S304), the CPU 31 advances the process to step S307.

In step S305, the CPU 31 notifies that the condition indicated by the attribute is satisfied. For example, the CPU 31 displays a predetermined message on the display unit 35 and/or emits an audio from a sound generation unit (not illustrated), to notify that the condition is satisfied. Therefore, a marine vessel satisfying the condition indicated by the attribute is a target for which a notification indicating that the condition is satisfied is given.

In step S307, the CPU 31 executes a warning process to notify that the condition indicated by the attribute is not satisfied. For example, the CPU 31 performs a warning process by displaying a predetermined warning message on the display unit 35 and/or emitting an audio from the sound generation unit (not illustrated). For example, in a case where the attribute target area 305 is a speed limit area, when the marine vessel 6 is traveling at an excessive speed in a slow down area in the attribute target area 305, it is warned that the marine vessel 6 is traveling at an excessive speed. In this way, a marine vessel that does not satisfy the condition indicated by the attribute is a target of the warning.

After steps S305 and S307, the CPU 31 executes another process in step S306, and returns the process to step S302. In other processes in the notification process, the CPU 31 may perform a process of ending the notification process based on an instruction from the marine vessel operator, for example. The CPU 31 may request acquisition of the map 18 again based on an instruction from the marine vessel operator.

Note that the notification process illustrated in FIG. 8 may be executed by the mobile terminal 4 or may be executed by cooperation of the microcomputer 5 and the mobile terminal 4.

The CPU 31 may store the notification contents and/or warning contents performed in steps S305 and/or S307, the date and time, the place, and the like thereof, in the memory 34 as the alert history information. In addition, the CPU 31 may store traveling track information indicating a traveling track which is a track on which the marine vessel 6 has traveled, in the memory 34. The CPU 31 may transmit the alert history information and the traveling track information to the server 2.

According to a preferred embodiment, the server 2 transmits the map 18 including the information on the boundary between the land area and the water area to the PC terminal 3. The PC terminal 3 designates the boundary line L1 (boundary range), the distance, and the attribute in the specific area on the map 18 based on the operation by the administrator. The PC terminal 3 transmits the designated boundary line L1, the designated distance, and the designated attribute to the server 2, and the server 2 acquires them. The server 2 sets the attribute target area 305 based on the boundary line L1 and the distance, and associates the attribute with the attribute target area 305. Then, the server 2 updates the map 18 by including the attribute target area 305 associated with the attribute in the map 18.

In this way, it is easy to set and register an appropriate attribute target area corresponding to a long coastline regardless of the situation of a place such as a marina. Therefore, the registration work of the area associated with the attribute can be facilitated.

In addition, the server 2 sets, as the area boundary line L11 (area boundary), a position spaced apart from the boundary line L1 by a designated distance on the opposite side of the boundary line L1 from the land area, and sets the attribute target area 305 with the area boundary line L11 as a reference. Therefore, the attribute target area 305 can be set based on the position spaced apart from the boundary line L1. In particular, the server 2 acquires the inside/outside designation information from the PC terminal 3, and sets, as the attribute target area 305, an area between the boundary line L1 and the area boundary line L11 or an area opposite to the boundary line L1 with respect to the area boundary line L11 according to the inside/outside designation. Therefore, the land side or the opposite side of the land with respect to the area boundary line L11 is set as the attribute target area 305 in accordance with the inside/outside designation information, which makes it possible for the administrator to easily reflect the intention in more detail.

Note that when the information on the boundary between the land area and the water area on the map 18 has been changed, the server 2 (for example, the transmission unit 401) may notify the administrator (PC terminal 3) corresponding to the specific area for which the information has been changed, of the change. As a result, it is possible to prompt the administrator to set and update the attribute target area for the area in which the information has been changed. Note that when the information on the boundary between the land area and the water area on the map 18 is changed, the server 2 may notify the PC terminals 3 corresponding to all the specific areas, of the change.

In a preferred embodiment, it is assumed that the boundary 303 (303A, 303B) between the land area and the water area on the map 18 is fixed regardless of the tide or the current. However, for example, the map 18 may be provided for each tide state. For example, in general, the boundary 303A at the time of high tide moves to the land side from the boundary 303A at the time of low tide.

In addition, when the attribute target area 305 is set for the map 18 having a fixed boundary regardless of the tide or current, the designated boundary range may be corrected or the area boundary may be corrected based on the tide information. For example, in a case where the tide information indicates a low tide, in order to set the attribute target area 305 suitable for the low tide, a correction process may be performed, as follows, on the map 18 based on the intermediate state between the high tide and the low tide. For example, in step S204 (FIG. 5), when setting the area boundary line L11 with the boundary line L1 as a reference, the CPU 11 may perform a correction by moving the position of the boundary line L1 or the area boundary line L11 in parallel by a predetermined amount so that the area boundary line L11 is set at a position moved more toward the sea.

In a preferred embodiment, the boundary line L1 and the like are exemplified as the designated boundary range, and the area boundary line L11 and the like are exemplified as the area boundary set with the boundary line L1 as a reference. However, the boundary range and the area boundary are not limited to a curve or a straight line. For example, the boundary range and/or the area boundary may be expressed by a plurality of points or may be expressed as an area having a predetermined width.

Note that the information processing system may need only to include a computer associated with an administrator who is authorized to set the attribute target area for the specific area, and a server communicably connected to the computer. Not only the PC terminal 3 but also the microcomputer 5 or the mobile terminal 4 can correspond to the computer associated with the administrator. Therefore, the information processing system can be realized by any of a combination of the server 2 and the PC terminal 3, a combination of the server 2 and the microcomputer 5, and a combination of the server 2 and the mobile terminal 4.

In a preferred embodiment, it is also possible to implement processing in which a program to implement one or more functions is supplied to a system or an apparatus via a network or a non-transitory storage medium, and one or more processors of a computer of the system or the apparatus reads and executes the program. The above program and the storage medium storing the above program correspond to other preferred embodiments of the present invention. Preferred embodiments of the present invention can also be implemented by a circuit (for example, ASIC) that implements one or more functions.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing apparatus comprising:
at least one memory to store a set of instructions; and
at least one processor configured or programmed to cause the information processing apparatus to:
transmit a map including information on a boundary between a land area and a water area;
acquire a designated boundary range among boundaries on the map, a designated distance, and a designated attribute;
set an attribute target area based on the designated boundary range and the designated distance, and associate the designated attribute with the attribute target area; and
update the map by including the attribute target area associated with the attribute in the map.

2. The information processing apparatus according to claim 1, wherein the at least one processor is configured or programmed to cause the information processing apparatus to:
set, as an area boundary, a position spaced apart from the designated boundary range by the designated distance on a side opposite to the land area with respect to the designated boundary range; and
set the attribute target area with reference to the area boundary.

3. The information processing apparatus according to claim 2, wherein the at least one processor is configured or programmed to cause the information processing apparatus to:
acquire inside/outside designation information indicating an inside or an outside of the area boundary; and
in a case where the inside/outside designation information indicates the inside of the area boundary, set an area between the designated boundary range and the area boundary as the attribute target area; and
in a case where the inside/outside designation information indicates the outside of the area boundary, set an area opposite to the designated boundary range with respect to the area boundary as the attribute target area.

4. The information processing apparatus according to claim 1, wherein
the attribute includes at least one of an area where a navigation speed of a marine vessel is limited, an area where a volume of audio is limited, or an area where entry of a marine vessel is prohibited.

5. The information processing apparatus according to claim 4, wherein the at least one processor is configured or programmed to warn a marine vessel that a condition indicated by the attribute has not been satisfied.

6. The information processing apparatus according to claim 1, wherein the at least one processor is configured or programmed to warn a marine vessel that a condition indicated by the attribute has been satisfied.

7. The information processing apparatus according to claim 1, wherein the at least one processor is configured or programmed to cause the information processing apparatus to associate the designated attribute with a tile corresponding to the attribute target area among a plurality of tiles defined by dividing a region on the map into a mesh shape.

8. The information processing apparatus according to claim 1, wherein the at least one processor is configured or programmed to cause the information processing apparatus to acquire the designated boundary range, the designated distance, and the designated attribute for each administrator who is authorized to set the attribute target area for a specific area on the map.

9. The information processing apparatus according to claim 8, wherein the at least one processor is configured or programmed to cause the information processing apparatus to, when there is a change in information on a boundary between a land area and a water area on the map, notify an administrator corresponding to a specific area in which the change has been made.

10. The information processing apparatus according to claim 2, wherein the at least one processor is configured or programmed to cause the information processing apparatus to correct the designated boundary range or correct the area boundary based on tidal information when setting the attribute target area.

11. An information processing system comprising:
a computer associated with an administrator who is authorized to set an attribute target area for a specific area; and
a server, communicably connected to the computer, to transmit to the computer a map including information on a boundary between a land area and a water area;
at least one memory to store a set of instructions; and
at least one processor; wherein
the at least one processor is configured or programmed to cause the computer to:
designate a boundary range, a distance, and an attribute, in the specific area on the map, based on an operation by the administrator; and
transmit the designated boundary range, the designated distance, and the designated attribute to the server; and
the at least one processor is configured or programmed to cause the server to:
acquire the designated boundary range, the designated distance, and the designated attribute, from the computer;
set the attribute target area based on the designated boundary range and the designated distance, and associate the designated attribute with the attribute target area; and
update the map by including the attribute target area associated with the attribute in the map.

12. The information processing system according to claim 11, wherein the at least one processor is configured or programmed to cause the computer to designate two points on the boundary on the map based on an operation by the administrator thus designating a range between the two points as the boundary range in the specific area.

13. An information processing method executed by a computer, the information processing method comprising:
transmitting a map including information on a boundary between a land area and a water area;
acquiring a designated boundary range among boundaries on the map, a designated distance, and a designated attribute;
setting an attribute target area based on the designated boundary range and the designated distance, and associating the designated attribute with the attribute target area; and
updating the map by including the attribute target area associated with the attribute in the map.

14. The information processing method according to claim 13, further comprising:
setting, as an area boundary, a position spaced apart from the designated boundary range by the designated distance on a side opposite to the land area with respect to the designated boundary range; and
setting the attribute target area with reference to the area boundary.

15. The information processing method according to claim 14, further comprising:
acquiring inside/outside designation information indicating an inside or an outside of the area boundary; and
in a case where the inside/outside designation information indicates the inside of the area boundary, setting an area between the designated boundary range and the area boundary as the attribute target area; and
in a case where the inside/outside designation information indicates the outside of the area boundary, setting an area opposite to the designated boundary range with respect to the area boundary as the attribute target area.

16. The information processing method according to claim 13, wherein
the attribute includes at least one of an area where a navigation speed of a marine vessel is limited, an area where a volume of audio is limited, or an area where entry of a marine vessel is prohibited.

17. The information processing method according to claim 16, further comprising:
warning a marine vessel that a condition indicated by the attribute has not been satisfied.

18. The information processing method according to claim 13, further comprising:
notifying a marine vessel satisfying a condition indicated by the attribute that the condition has been satisfied.

19. The information processing method according to claim 13, further comprising:
associating the designated attribute with a tile corresponding to the attribute target area among a plurality of tiles defined by dividing a region on the map into a mesh shape.

20. The information processing method according to claim 13, further comprising:
acquiring the designated boundary range, the designated distance, and the designated attribute for each administrator who is authorized to set the attribute target area for a specific area on the map.

21. The information processing method according to claim 20, further comprising:
when there is a change in information on a boundary between a land area and a water area on the map, notifying an administrator corresponding to a specific area in which the change has been made.

22. The information processing method according to claim 14, further comprising:
correcting the designated boundary range or correcting the area boundary based on tidal information when setting the attribute target area.

23. A non-transitory storage medium storing a computer-executable program for executing an information processing method, the information processing method comprising:
transmitting a map including information on a boundary between a land area and a water area;
acquiring a designated boundary range among boundaries on the map, a designated distance, and a designated attribute;
setting an attribute target area based on the designated boundary range and the designated distance, and associating the designated attribute with the attribute target area; and
updating the map by including the attribute target area associated with the attribute in the map.
